(19) United States
(12) Patent Application Publication
(10) Pub. No.: US 2016/0140794 A1
(43) Pub. Date: May 19, 2016

(54) GAMING DEVICE WITH SYMBOLS SWAPPING POSITIONS

(71) Applicant: GTECH Canada ULC, Moncton (CA)

(72) Inventor: Lee Tanner, Irishtown (CA)

(21) Appl. No.: 14/547,568

(22) Filed: Nov. 19, 2014

(51) Int. Cl. G07F 17/32; G07F 17/34

(52) U.S. Cl. CPC G07F 17/3213; G07F 17/34

(57) ABSTRACT

A video gaming machine has M reels, each displaying N symbols when stopped. After a spin of the virtual reels, an initial array of randomly selected symbols is displayed. A processor randomly highlights a symbol in the array that has the feature of swapping positions with any other displayed adjacent symbol. The player has the option to swap the selected symbol with any adjacent symbol by swiping it or touching a displayed arrow. An award is then based on any resulting winning combinations after the swap. The swapping feature may occur only if there are no winning symbol combinations after the spin or may occur for every game. Awards may be granted after the spin and after the swap, or awards may only be granted only after the swap. Therefore, there is an amount of player strategy in the direction of the swap or deciding not to swap at all.

### FIELD OF THE INVENTION

This invention relates to gaming devices, such as video slot machines displaying virtual reels, and, in particular, to a special game feature where symbols on the reels can swap positions after a spin under control of the player to add a level of skill to the game.

### BACKGROUND

Common video slot machines randomly select and display an array of symbols using virtual reels, then grant an award to a player based on the occurrence of certain symbol combinations across paylines. Typically, the game ends after a single spin of the reels and any award is granted.

It is known to provide a nudge feature in a reel-type game, where, after an initial spin, the player is allowed to control one or more reels to nudge the reels one stop position up or down to give the player another opportunity for a win. In such a case, all the symbols on the nudged reel move up or down together. Also with the conventional nudge feature, the symbols cannot move left and right. As seen, the conventional nudge feature has some inherent limitations on achieving new winning symbols combinations after the original spin.

What is desirable, for increase player interest, is a variation on the nudge feature that does not have the above-described limitations. Such a gaming machine will generate increased revenue to the casino by increased play of the gaming machine.

What is also desirable is to provide a game the meets certain jurisdictions' requirements for a skill based game, where an outcome is affected by a player's decision rather than being purely random.

### SUMMARY

One embodiment of the present invention may be implemented by a conventional-platform video slot machine that is suitably programmed. The invention can also be implemented by a home computer playing a slot machine type game, or by any personal computing device, such as a smartphone, connected to a wireless network such as the Internet.

Various embodiments of the game are described. In one embodiment, a video slot machine has five vertically oriented reels, each displaying three symbols per reel when randomly stopped. Other size arrays may also be used, such as 3×3, 4×5, 5×5, etc.

After a spin of the virtual reels, an initial 3×5 array of randomly selected symbols is displayed. The term randomly also includes pseudo-randomly.

In one embodiment, no awards are granted after the spin since there is no player skill involved in the win. For certain jurisdictions, such as Georgia, a gaming machine must involve some level of player skill to obtain the final outcome. Thus, any awards are only granted after the player has had the chance to swap a symbol, as described below. In such an embodiment, the symbol swap feature is provided for every game irrespective of the outcome of the spin.

In another embodiment, if there is a winning symbol combination immediately after the spin, the corresponding credits are paid to the player, as is conventional. In one embodiment, the inventive symbol swap feature is provided after every game played, whether or not there is a win after the initial spin. In another embodiment, the feature is only enabled if there is no win after the initial spin.

Assuming the feature is enabled after the initial spin, the following occurs.

The gaming machine's processor randomly selects and highlights a symbol in the 3×5 array. The player is then allowed to swap the position of the selected symbol for any other adjacent symbol position. In one embodiment, to aid the player, arrows are displayed around the selected symbol that show the possible directions of movement of the selected symbol. If the selected symbol is near the middle, then the arrows may include up, down, left, and right arrows. If the selected symbol is a bottom right corner symbol, the arrows would only be up and left arrows.

The player then has the option to move the selected symbol in any one of the directions indicated by the arrows by touching the appropriate arrow or swiping the symbol in that direction. The symbol will then swap positions with the adjacent symbol. An award is then based on any resulting winning combinations. Therefore, it is possible that two or more new winning combinations may be created by the selected symbol being in a new winning combination and the other swapped symbol (which replaced the selected symbol) creating another new winning symbol combination. It is also possible that the player may make a wrong decision and negate an initial winning symbol combination when swapping the symbols.

In one embodiment, if the processor detects a possible winning combination for a particular move of the selected symbol, the possible winning combination is highlighted, such as by darkening all other symbols that would not be involved in the win, and the player can then easily see which way to move the selected symbol to obtain the highest award. After the swap, the player is awarded the appropriate prize for the winning combination.

In one embodiment, the player has the option of not moving the selected symbol and just taking the winning symbol combinations that existed after the spin.

The feature is skill-based since the player has the option of moving the selected symbol to any of the available adjacent positions, where the direction of movement affects the outcome of the game.

In another embodiment, the processor detects, after the initial spin, whether it is even possible for a symbol swap to result in a winning combination. If not, the processor may not enable the feature since there is no possibility of a win after any symbol swap. This saves time and avoids frustration by the player.

As seen, the feature adds another level of excitement to the conventional video slot machine game and allows the player to become more involved in the outcome of the game. As a result, the player will typically play longer. Additionally, the player is given two opportunities to win, which is perceived by the player as increasing the chances of winning greater awards.

Other embodiments are described.

### BRIEF DESCRIPTION OF THE DRAWINGS

FIG. 1 illustrates a gaming machine that is programmed to display a 3×5 array of symbols and carry out the symbol swap feature game, in accordance with one embodiment of the present invention.

FIG. 2 illustrates an example of the screen image displayed by the machine of FIG. 1 after a spin of a paid game. In the example, no winning symbol combinations are in the initial array.

FIG. 3 illustrates how the processor randomly selected the bottom center symbol to have the symbol swap feature. FIG. 3 also illustrates how the processor highlights a possible winning combination and displays arrows indicating the possible directions the player can move the selected symbol to create new symbol combinations.

FIG. 4 illustrates how the player moved the selected symbol up one position to create a winning combination of four Kings, and how the replaced symbol swapped positions with the selected symbol. The appropriated award is then paid for the new winning symbol combination.

FIGS. 5, 6, and 7 illustrate a possible progressive animation showing the selected symbol swapping positions with the symbol above it to create the array of FIG. 4.

FIG. 8 is a flowchart of various steps used in carrying out the game of FIGS. 1-4.

FIG. 9 is a block diagram illustrating various functional units in a gaming machine, where the machine is programmed to carry out the invention.

Elements that are the same or similar are designated with the same numeral in the various figures.

### DETAILED DESCRIPTION

Although the invention can typically be implemented by installing a software program in most types of modern video gaming machines, one particular gaming machine platform will be described in detail.

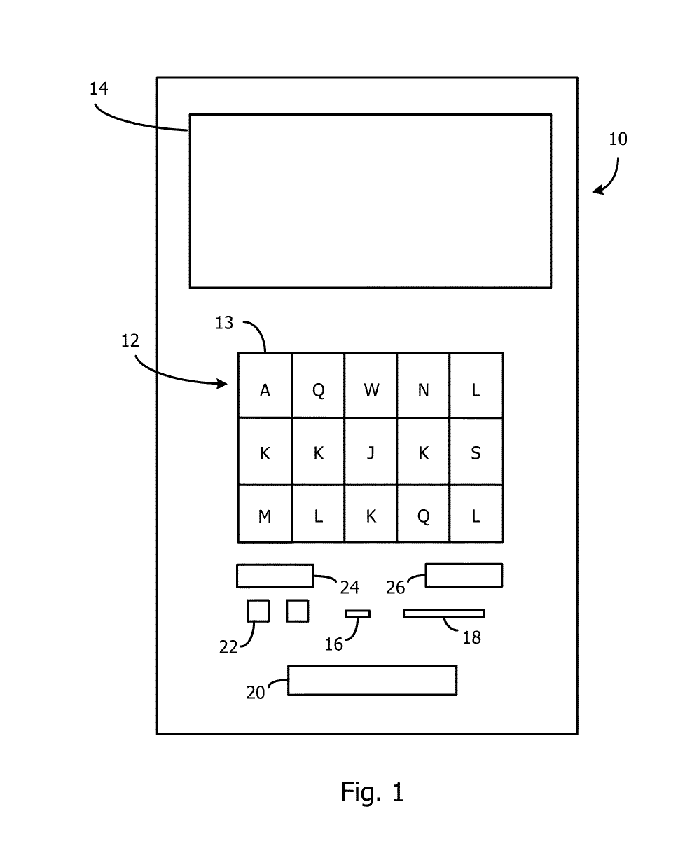

FIG. 1 illustrates a video gaming machine 10 that includes a main display, which is a bottom display 12 in the example (or bottom display area). The main display may be a thin film transistor (TFT) display, a liquid crystal display (LCD), a cathode ray tube (CRT), or any other type of display. In FIG. 1, the base game shown in the display 12 is the spinning and stopping of five virtual symbol reels 13, where each reel 13 displays three symbols when stopped, creating a 3×5 array of symbols. At the end of the game, an award is granted, as determined by a processor, based on symbol combinations across activated paylines, such as horizontal and zig-zag paylines.

A secondary display, which is a top display 14 in the example or an upper display area of a large screen, may display the name of the game and the awards associated with winning symbol combinations.

A coin/token receiver 16 accepts coins or tokens in one or more denominations to generate credits within the machine 10 for playing games. An input slot 18 accepts various denominations of banknotes or machine-readable tickets, and may output printed tickets for use in cashless gaming. A coin tray 20 receives coins or tokens from a hopper upon a win or upon the player cashing out. Player control buttons 22 include any buttons needed for the play of the games offered by the machine 10 including, for example, a bet button, a max-bet button, a spin reels button, a cash-out button, and any other suitable button. Pressing the bet button multiple times multiplies the bet. Buttons 22 may be virtual buttons on a touch screen.

Each bet deducts credits from a credit meter 24 that stores the accumulated credits from wins and the insertion of money. If the player cashes out, all the credits in the credit meter 24 are paid to the player. A game win meter 26 identifies the amount won for the present game.

All credit meters, all control buttons, and the entire game may be displayed on a single large touch screen.

FIG. 1 illustrates an arbitrary, randomly selected symbol array determined by the five virtual reels 13 spinning and randomly stopping during a base game. The virtual reel strips may contain any conventional symbols in the conventional aspect of the game. Such conventional symbols are denoted by letter symbols at the various symbol positions. Such conventional symbols may also include wild symbols, scatter symbols, and other types of known symbols. The stopping position of each reel is determined by a pseudo-random number generator in the machine 10.

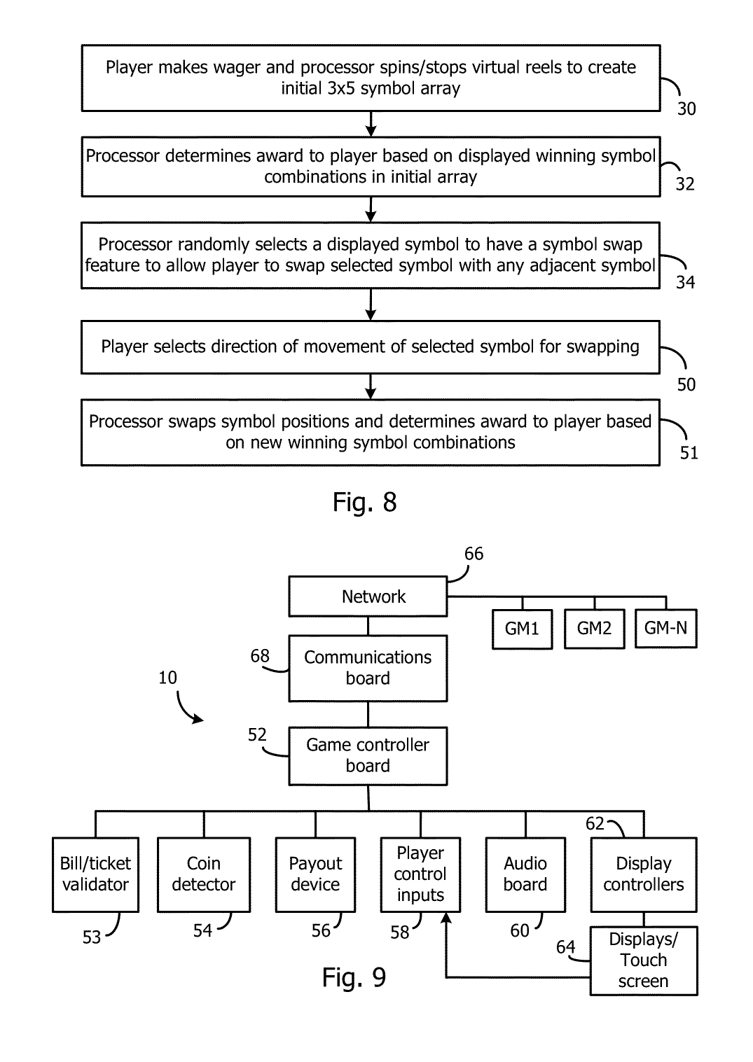

The operation of the inventive aspect of the game will be described with respect to the example screen shots of FIGS. 2-7 and the flowchart of FIG. 8.

In step 30 of FIG. 8, the player makes a wager and initiates a game by touching a spin-reels button. The machine's processor controls the display and stops the virtual reels at a random stop position to create a 3×5 array of symbols. Any size array may be used in the invention.

FIG. 2 illustrates an example of the screen image displayed by the machine 10 of FIG. 1 on display 12 after a spin of the reels in a paid game.

In one embodiment, no award is paid to the player for winning symbol combinations occurring immediately after the spin since the award would not be based on any player skill However, in another embodiment, the player is paid an award for any winning symbol combinations after the spin, as shown in step 32.

In step 32 of FIG. 8, the processor determines, and pays, any award to the player for winning symbol combinations in the displayed array. In the example, no winning symbol combinations are in the initial array.

In step 34, for each paid game, the processor randomly selects a displayed symbol to have a symbol swap feature to allow the player to swap the selected symbol with any of its adjacent symbols. Arrows are displayed around the selected symbol to illustrate to the player the possible directions for the swap. In one embodiment, the symbol swap feature is only enabled if there are no winning symbol combinations in step 32.

In one embodiment, the symbol swap feature is enabled for every game irrespective of any initial winning symbol combinations. If the symbol swap feature is enabled even if the player wins an award after the spin, the player can win twice in a single game and even break up an initial winning combination to form a new winning combination. In another embodiment, the symbol swap feature is only enabled if there are no winning symbol combinations after the spin, or if the initial award amount is below a threshold amount. In such an embodiment, if there is a winning symbol combination after the spin, the processor ends the game. In an embodiment where a skill-based game is required to meet jurisdictional requirements, the symbol swapping feature is required to occur prior to any awards being assessed for the final array display.

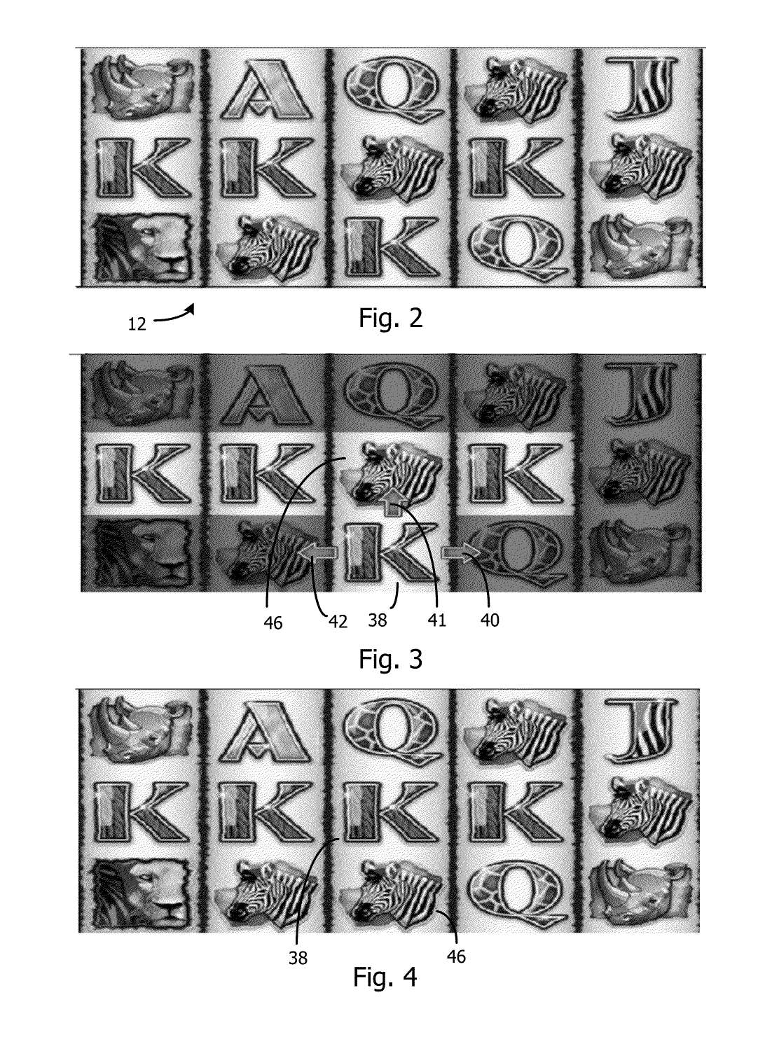

FIG. 3 illustrates an example of step 34, where the processor randomly selected the bottom center symbol 38 to have the symbol swap feature. The arrows 40-42 are shown indicating that the player may move the symbol 38 up, left, or right. The available possible movements are dependent on the position of the selected symbol, since the player can only swap the symbol with another displayed symbol. FIG. 3 also illustrates how the processor highlights a possible winning combination (a potential four contiguous Kings across a payline starting from the leftmost reel). The player will therefore most likely want to move the symbol 38 (a King) upward to replace the non-King symbol 46 in order to achieve the four Kings. In one embodiment, the player may elect to not move the symbol by touching the symbol itself.

In step 50, the player selects the direction of movement of the symbol 38 by touching one of the arrows 40-42 or swiping the symbol 38. In this example, the display screen is a touch screen.

In step 51, the processor swaps the symbol positions, as selected by the player, and determines any award for new winning symbol combinations that have been created.

FIG. 4 illustrates how the player moved the selected symbol 38 up one position to create a winning combination of four Kings, and how the replaced symbol 46 swapped positions with the selected symbol 38. The appropriated award is then paid for the four Kings. If the new position for the symbol 46 created another new winning symbol combination, the player would have been also granted an award for that combination. The credit meter 24 of FIG. 1 is then incremented by the awarded credits.

The game then ends.

In another embodiment, all award determinations are only made after the symbol swap has occurred, so the player may break up an initial winning symbol combination to create a better winning symbol combination and only get an award for the better winning symbol combination. Swapping of a symbol may result in multiple winning symbol combinations occurring, so the player must use some strategy in her decision. If the player is satisfied with the initial positions of all the symbols, the player may opt to not swap any symbols by just touching the center of the highlighted symbol.

In one embodiment, if the processor determines that there are no possible swaps that can create a new winning symbol combination once the initial array has been displayed, step 34 is not performed to save time and player frustration.

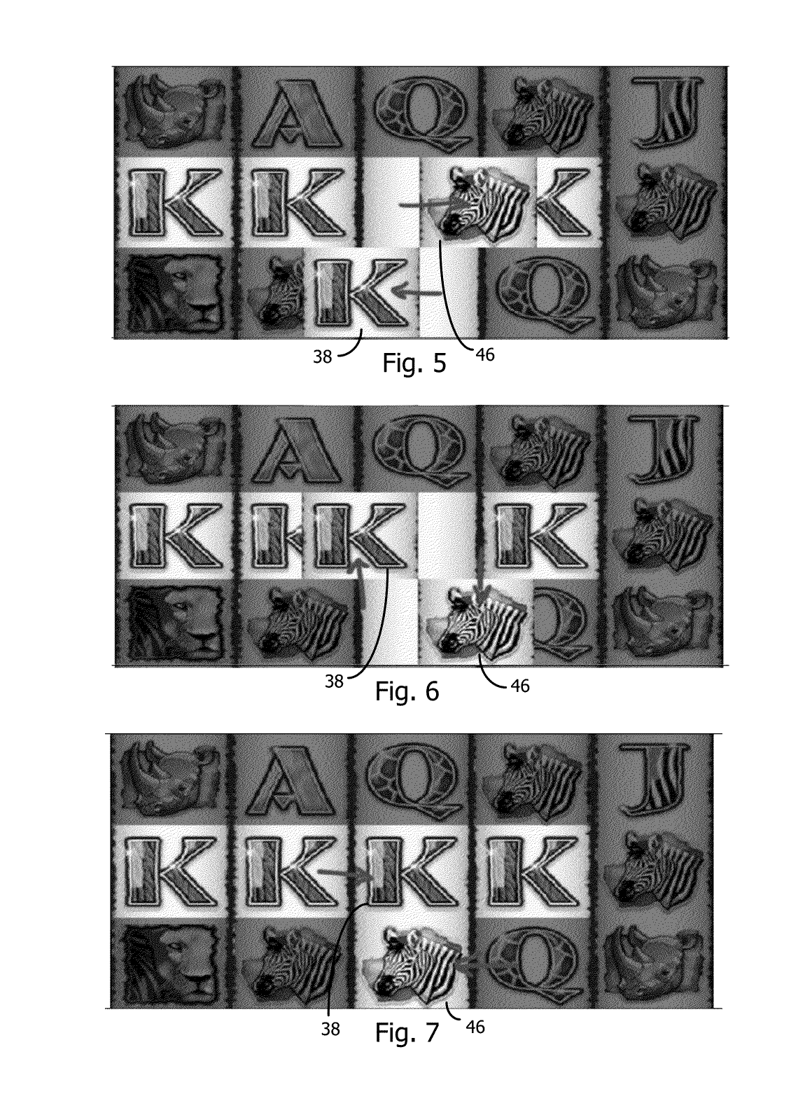

FIGS. 5, 6, and 7 illustrate a possible progressive animation showing the selected symbol 38 swapping positions with the symbol 46 above it to create the array of FIG. 4. The animation may take, for example, 3 seconds.

In FIG. 5, once the player selects the direction of movement of the symbol 38, the symbol 38 is partially shifted to the left and the symbol 46 is shifted to the right.

In FIG. 6, the symbol 38 is shifted up and the symbol 46 is shifted down.

In FIG. 7, the symbol 38 is shifted right and the symbol 46 is shifted left to reform the array. Generally, the shifting is in a clockwise direction.

In another embodiment, there may be a trigger event that enables the symbol swap feature, such as the player making a maximum bet, or due to an outcome of a game, or due to another random event.

In another embodiment, the processor may select more than one symbol in the array that can be swapped.

Since there is some level of skill in the game, because the player's swapping decision affects the outcome, this may enable the game to be practiced in certain jurisdictions that allow only skill-based games.

FIG. 9 illustrates basic circuit blocks in the machine 10 of FIG. 1 and portions of a network. A game controller board 52 includes a processor (CPU), or multiple processors, that runs the gaming program (including any or all aspects of the present game) stored in a game control memory which may be a program read only memory (ROM), such as a compact disk (CD). That is, the game control memory stores code for directing the processor to execute game operations including, for example, the operations described with reference to FIGS. 1-8. The processor associated with the game controller board 52 may include a single processor or a plurality of processors. The program ROM may include a pseudo-random number generator program for selecting symbols and for making any other random selections. That is, pseudo random number generator code may be stored in the game control memory and may be executed by the processor to select symbols and make other random selections. At least the active portion of the gaming program may be stored in a random access memory (RAM) on the board 52 for access by the processor system. A paytable ROM on the board 52, under control of the processor, identifies awards to be paid to the player pursuant to displayed winning symbol combinations.

A bill/ticket validator 53 and coin detector 54 add credits for playing games. A payout device 56 pays out an award to the player in the form of coins or a printed ticket at the end of a game or upon the player cashing out. Player control inputs 58 receive push-button or touch screen inputs for making player selections. An audio board 60 sends signals to the speakers. A display controller 62 receives commands from the processor or network and generates signals for the various displays 64.

Modern gaming machines are connected within a network for remote monitoring of the machines. The game controller board 52 transmits and receives signals to and from a network 66 via a communications board 68. The network 66 includes servers and other devices that monitor the linked gaming machines 10 and GM1-GM-N.

The electronics on the various boards may be combined onto a single board. Various functional units would be deleted for cashless gaming.

The gaming system has been described above as a dedicated physical gaming machine in a casino or other establishment. However, the gaming machine 10 may be a suitable generic computer or mobile device (smartphone, tablet, etc.) connected to a network/server via the internet and programmed to carry out the inventive methods. The gaming machine 10 of FIG. 1 may itself be a screen image in a virtual casino. Icon selection may be by touch screen, a mouse, a joystick, or other means. The gaming system may access a gaming site or a social website (e.g., Facebook) via the internet, wherein the remote gaming site controls various aspects of the game and allows remote players to participate in games using a virtual gaming machine. The player's inputs may be transmitted to a remote server and the results displayed to the player's display screen. For example, a player's mobile computing system (e.g., a smartphone) may detect winning symbol combinations by signals from the server informing the computing system that a winning combination has occurred. For gaming via the internet, the wagering would typically be by credit card or accessing an existing account. Awarding the player may be by crediting the player's account. For portable computing devices, Near Field Communications (NFC), such as Bluetooth, may be used as a player interface to play on an actual or virtual gaming machine 10.

Those skilled in the art may write the appropriate software to carry out the invention without undue experimentation. The hardware used may be conventional.

The term “random” used herein refers to pure random as well as pseudo-random.

While particular embodiments of the present invention have been shown and described, it will be obvious to those skilled in the art that changes and modifications may be made without departing from this invention in its broader aspects and, therefore, the appended claims are to encompass within their scope all such changes and modifications as fall within the true spirit and scope of this invention. For example, the bonus trigger may be any symbols combination and only award one free game. Any of the features described herein may be combined into a game.

What is claimed is:

1. A method performed by a video gaming device to achieve a skill-based game, the device comprising at least a display system and a processing system, the method comprising:
a. receiving a wager amount by a player;
b. receiving a signal by the player to initiate play of a game;
c. displaying on the display system the virtual spinning and stopping of M virtual reels in the game, where each of the M reels has N symbols displayed on it when stopped to form an initial M×N array of symbols, where M and N are greater than one;
d. after the initial M×N array of symbols has been displayed, randomly selecting by the processing system a symbol in the array of symbols to be a selected symbol for a swapping feature;
e. highlighting the selected symbol to the player and enabling the player to swap the selected symbol with any adjacent displayed symbol;
f. detecting by the processing system a control signal from the player identifying a desired direction of movement of the selected symbol for swapping the selected symbol with a particular adjacent symbol;
g. swapping the selected symbol with the particular adjacent symbol; and
h. granting an award for any winning symbol combinations in the resulting array of symbols after the step of swapping.

2. The method of claim 1 further comprising determining by the processing system whether there is a winning symbol combination in the initial M×N array of symbols and then performing the step of selecting the selected symbol for a swapping feature only if there are no winning symbol combinations in the initial M×N array of symbols.

3. The method of claim 1 further comprising the processing system highlighting a possible winning combination of symbols prior to enabling the player to swap the selected symbol with any adjacent displayed symbol to give the player a suggestion for swapping the selected symbol with an adjacent symbol.

4. The method of claim 1 wherein the M×N array of symbols comprises a 5×3 array of symbols.

5. The method of claim 1 further comprising the processing system controlling the display system to display directional arrows next to the selected symbol to identify possible directions that the selected symbol can be moved.

6. The method of claim 5 wherein the control signal from the player for identifying a desired direction of movement of the selected symbol comprises the player touching one of the arrows.

7. The method of claim 1 wherein the control signal from the player for identifying a desired direction of movement of the selected symbol comprises the player swiping the selected symbol in a particular direction.

8. The method of claim 1 wherein no award determination is made after the initial M×N array of symbols is displayed and before the step of swapping, and the selected symbol may be within a winning symbol combination in the initial array of symbols so as to allow the player to create a different winning symbol combination after the step of swapping.

9. The method of claim 1 wherein the step of selecting occurs after every spin of the reels irrespective of an outcome of the spin.

10. The method of claim 1 wherein the display system and processing system are part of a dedicated video gaming machine.

11. The method of claim 1 wherein the display system and processing system are part of a multi-use computing device programmed to carry out the game.

12. The method of claim 1 wherein the display system and processing system are part of a portable computing device programmed to carry out the game via the Internet.

13. A video gaming device that plays a skill-based game comprising:
a display system for displaying a game to a player;
a processing system programmed to carry out the game, the processing system being programmed to carry out the method comprising:
a. detecting a wager amount by a player;
b. detecting a signal by the player to initiate play of the game;
c. displaying on the display system the virtual spinning and stopping of M virtual reels in the game, where each of the M reels has N symbols displayed on it when stopped to form an initial M×N array of symbols, where M and N are greater than one;
d. after the initial M×N array of symbols has been displayed, randomly selecting by the processing system a symbol in the array of symbols to be a selected symbol for a swapping feature;
e. highlighting the selected symbol to the player and enabling the player to swap the selected symbol with any adjacent displayed symbol;
f. detecting by the processing system a control signal from the player identifying a desired direction of movement of the selected symbol for swapping the selected symbol with a particular adjacent symbol;
g. swapping the selected symbol with the particular adjacent symbol; and
h. granting an award for any winning symbol combinations in the resulting array of symbols after the step of swapping.

14. The structure of claim 13 wherein the processing system is further programmed to perform the step comprising determining by the processing system whether there is a winning symbol combination in the initial M×N array of symbols and then performing the step of selecting the selected symbol for a swapping feature only if there are no winning symbol combinations in the initial M×N array of symbols.

15. The structure of claim 13 wherein the processing system is further programmed to perform the step comprising the processing system highlighting a possible winning combination of symbols prior to enabling the player to swap the selected symbol with any adjacent displayed symbol to give the player a suggestion for swapping the selected symbol with an adjacent symbol.

16. The structure of claim 13 wherein the M×N array of symbols comprises a 5×3 array of symbols.

17. The structure of claim 13 wherein the processing system is further programmed to perform the step comprising the processing system controlling the display system to display directional arrows next to the selected symbol to identify possible directions that the selected symbol can be moved.

18. The structure of claim 13 wherein no award determination is made after the initial M×N array of symbols is displayed and before the step of swapping, and the selected symbol may be within a winning symbol combination in the initial array of symbols so as to allow the player to create a different winning symbol combination after the step of swapping.

19. The structure of claim 13 wherein the step of selecting occurs after every spin of the reels irrespective of an outcome of the spin.

20. The structure of claim 13 wherein the display system and processing system are part of a dedicated video gaming machine.

21. The structure of claim 13 wherein the display system and processing system are part of a multi-use computing device programmed to carry out the game.

22. The structure of claim 13 wherein the display system and processing system are part of a portable computing device programmed to carry out the game via the Internet.
